(19) United States
(12) Patent Application Publication
(10) Pub. No.: US 2005/0200552 A1
(43) Pub. Date: Sep. 15, 2005

(54) Passive tunable broadband antenna

(76) Inventor: Ronald Craig Davidson, Paris (FR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/513,061

(22) PCT Filed: Apr. 29, 2003
(86) PCT No.: PCT/FR03/01341

§ 371 Date: May 13, 2005

(30) Foreign Application Priority Data
Apr. 29, 2002 (FR) 02/05349

(51) Int. Cl. H01Q 21/00

(52) U.S. Cl. 343/895; 343/893

(57) ABSTRACT

The invention concerns a passive tunable broadband antenna. The antenna radiating element consists of stacked toroids (T) connected in series, means (a, c) being provided for shorting the toroids individually and at will, and means (b, d) being provided for interrupting the connection between any two successive toroids. The invention is particularly applicable to the 30-412 MHz operating range.

The invention relates to a wideband connectable passive antenna.

A purpose of the invention is, in particular, to provide an antenna that can operate in a range as wide as the 30-512 MHz range.

To cover such a range, a solution consisting in at least two antennas with very different lengths; that is, typically a 2.5 m antenna connected at 30 MHz and a 15 cm antenna connected at 512 MHz, preferably to a single antenna whose radiation diagram could not be satisfactory at the same time for both these frequencies.

Various single antenna solutions have nonetheless been suggested to comprise a wideband connectible passive antenna.

A frequent suggested solution consists in using a radiating element made up of several serial linked inductors and providing resources for short-circuiting the inductors individually and on demand (see, for example, U.S. Pat. No. 4,564,843, U.S. Pat. No. 4,656,483, U.S. Pat. No. 4,862,184, U.S. Pat. No. 4,924,238, U.S. Pat. No. 6,169,523), which allows connecting the antenna at different frequencies according to the number of short-circuited elements.

This solution allows obtaining high selectivity at the lowest operating frequency, but this selectivity decreases as the frequency increases.

A purpose of this invention is to provide an antenna whose selectivity is satisfactory in a very wide range of operating frequencies.

According to the invention, this is obtained with an antenna that includes a radiating element comprised of several serial linked inductors and that includes resources for short-circuiting the inductors individually and on demand, characterised in that the antenna also includes resources for interrupting the link between any two successive inductors, in that each inductor is designed to limit a space surrounded by the inductor and in which the magnetic field generated by the passage of a current in the inductor is located, in that the inductors are distributed in such a way that the spaces are overlapping, and in that the resources for short-circuiting the inductors and the resources for interrupting the links between the inductors include switches positioned near the inductors and linked to command resources placed remotely by means of electric conductors that cross said overlapped spaces.

Preferably, the conductors are passed in a metal tube in the middle of the spaces.

Preferably, the inductors are comprised of toroids whose own resonance frequency is chosen to be greater at the highest operating frequency of the antenna.

The use of toroids for comprising a radiating element of an antenna is known per se (see, for example, publications U.S. Pat. No. 4,622,588 and U.S. Pat. No. 5,422,369), but none of these publications indicate the use of a series of toroids to create an antenna connectable over an entire range of frequencies.

This invention therefore allows connecting the antenna to a wide range of frequencies and varies its length according to the connection frequency, so that the selectivity of the antenna is maintained at a high value.

The figures of the attached drawing are diagrams of an example of an antenna according to the invention, in which represented are two elements from among all the elements that comprise the radiation element of the antenna:

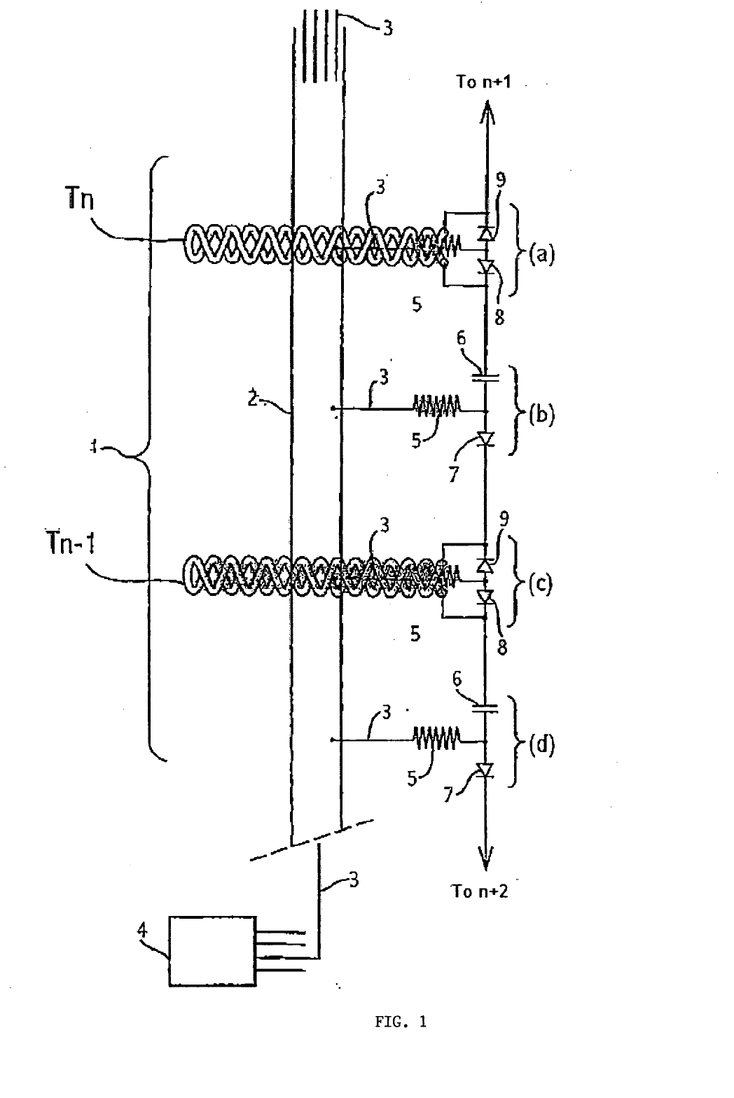

FIG. 1 is a view in a vertical plane where the side view of the inductors is shown.

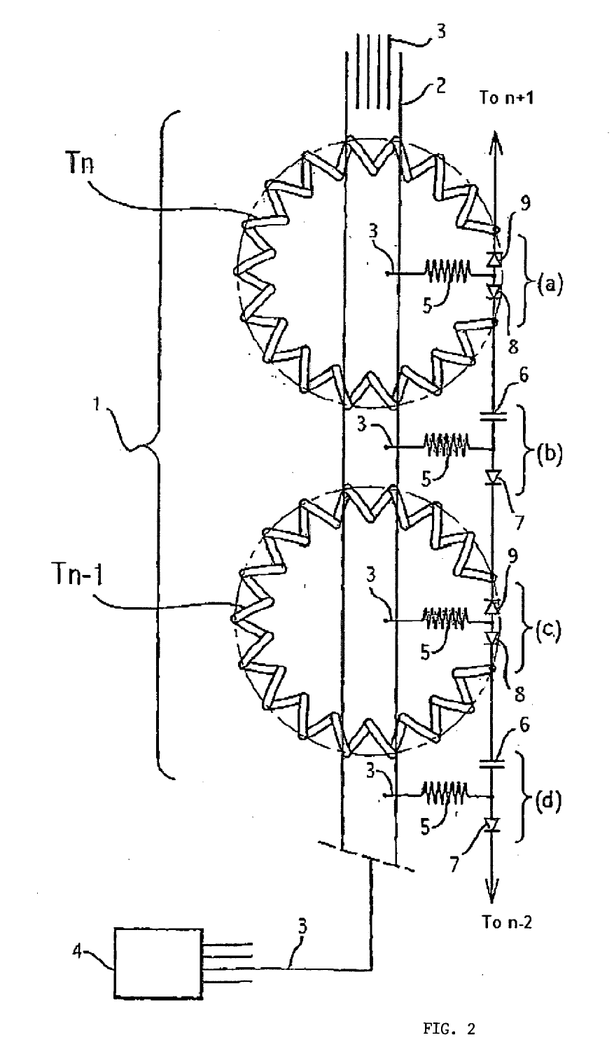

FIG. 2 is an analogue view in a vertical plane, but where the inductors are shown on the plane.

The radiating element (1) of the antenna is comprised of toroids (Tn-1), (Tn), etc. positioned horizontally. The toroids can have any shape (circle, polygon, square, triangle, etc.), as long as the magnetic field generated by the passage of an electrical current in the toroids is located in a limited area, which considerably reduces the mutual inductance between the various toroids. The set of toroids is crossed by a metal tube (2) inside of which pass the conductors (3) that are linked by the decoupling (5) inductors to the switches that includes switches such as (b) and (d) that serve to cut the successive toroids and switches such as (a) and (c), which serve to short-circuit the toroids individually.

The various toroids have identical or different individual resonance frequencies, but that are external to the operating band of the antenna.

Drawn on the Figures are command resources of switches using a rectangle (4).

Switches are comprised, in this example and in a manner known per se, of capacity-transistor pairs (6,7) or opposed transistor pairs (8,9), depending on whether switches (b) and (d) or switches (a) and (c) are being referred to.

The invention is not limited to this embodiment example.

1. Wideband connectable antenna, that includes a radiating element (1) comprised of several serial linked inductors that include resources (a, c) to short-circuit the inductors individually and on demand, characterised in that the antenna also includes resources (b, d) for interrupting the link between any two successive inductors, in that each inductor is designed to limit a space surrounded by the inductor and in which the magnetic field generated by the passage of a current in the inductor is located, in that the inductors are distributed in such a way that the spaces are overlapping, and in that the resources (a, c) for short-circuiting the inductors and the resources (b, d) for interrupting the links between the inductors include switches positioned near the inductors and linked to command resources (4) placed remotely by means of electric conductors (3) that cross said overlapped spaces.

2. Antenna according to claim 1 and that includes a metal tube (2) in which said conductors (3) pass.

3. Antenna according to claim 2 and in which said metal conductor (2) passes to the centre of said spaces.

4. Antenna according to claims 1 to 3, in which the inductors are comprised of toroids (T).

5. Antenna according to claim 4 in which the toroids (T) have, in a plane, a shape selected from the following shapes: circles, polygon, square, triangle.

6. Antenna according to claim 4 in which the own resonance frequency of the toroids (T) is selected to be greater than the highest operating frequency of the antenna.
